(19) United States
(12) Patent Application Publication
(10) Pub. No.: US 2026/0295499 A1
(43) Pub. Date: Oct. 1, 2026

(54) CONSTANT GAS-PHASE ORGANIC COMPOUND CONCENTRATION GENERATION APPARATUS AND PRETREATMENT METHOD THEREOF

(71) Applicant: SHENZHEN UNIVERSITY, Shenzhen (CN)

(72) Inventors: Jinhan MO, Shenzhen (CN); Zhuo CHEN, Shenzhen (CN)

(21) Appl. No.: 19/633,833

(22) Filed: Mar. 30, 2026

(30) Foreign Application Priority Data
Apr. 1, 2025 (CN) 202510397701.1

(51) Int. Cl. B01D 53/04; B01J 20/12; B01J 20/24

(52) U.S. Cl. CPC B01D 53/0438; B01D 53/0446; B01D 53/0454; B01J 20/12; B01J 20/24; B01D 2253/11; B01D 2253/202; B01D 2253/25; B01D 2257/708

(57) ABSTRACT

A constant gas-phase organic compound concentration generation apparatus and a pretreatment method thereof are provided in the present application. The apparatus includes a cabin body and a generating source. The cabin body has a sealable first inner cavity, and the generating source is arranged in the first inner cavity. The generating source includes a carrier and a target organic compound. The target organic compound is mixed within the carrier and is configured to be released from the carrier. The apparatus has a simpler structure, lower cost, significantly reduced footprint, and is simple and convenient to operate. Since the content of the target organic compound in the generating source is determinable, the organic compound concentration within the cabin body is also determinable, thus ensuring the concentration of compounds and semi-volatile organic compounds inside the cabin body.

### CROSS REFERENCE TO RELATED APPLICATIONS

Pursuant to 35 U.S.C. § 119 and the Paris Convention, this application claims the benefit of Chinese Patent Application No. 202510397701.1 filed Apr. 1, 2025, the contents of which are incorporated herein by reference.

### TECHNICAL FIELD

The present application relates to the field of gas-phase organic compound generation, and particularly to a constant gas-phase organic compound concentration generation apparatus and a pretreatment method thereof.

### BACKGROUND

The generation of a constant and controllable concentration of a gas-phase organic compound is crucial in various application fields, such as scientific research, air quality sensor calibration testing, industrial process control, and odor and fragrance development, among others. In the existing art, a dynamic dilution method is mainly employed to generate the gas-phase organic concentration. High-concentration organic vapor introduced from a gas cylinder or by evaporating liquid organic compounds is mixed with clean air or an inert gas such as nitrogen to achieve the required concentration. However, gas-phase organic concentration generation apparatus adopting the dynamic dilution method suffers from the drawback of having a complex structure.

### SUMMARY

A constant gas-phase organic compound concentration generation apparatus is provided in the present application. The apparatus is configured for solving the technical problem of the complex structure of the gas-phase organic compound concentration generation apparatus in the existing art.

The application provides a constant gas-phase organic compound concentration generation apparatus, which includes: a cabin body and a generating source. The cabin body has a sealable first inner cavity. The generating source is arranged in the first inner cavity.

The generating source includes a carrier and a target organic compound. The target organic compound is mixed within the carrier, and is configured to be mass-transferable into the first inner cavity.

Optionally, the generating source is constructed as a film structure, and the film structure is disposed within the first inner cavity.

Optionally, a protective layer is provided on an inner wall of the cabin body, and the generating source is disposed on the protective layer.

Optionally, the generating source is provided with a packaging structure for encapsulating the generating source. The packaging structure includes a substrate layer and a film layer. The generating source is disposed on the substrate layer. The film layer covers a side of the generating source opposite to the substrate layer, and the film layer is configured to be removable from the generating source. The generating source adheres to the inner wall of the cabin body via the substrate layer.

Optionally, the carrier includes at least one of starch, bentonite, and methyl cellulose (or poly(methyl cellulose)). Furthermore/Alternatively, the target organic compound includes at least one of benzene, toluene, trichloroethylene, phthalate esters, organophosphate esters, and polybrominated diphenyl ethers.

Optionally, the constant gas-phase organic compound concentration generation apparatus further includes a temperature control mechanism for controlling a temperature in the first inner cavity.

Optionally, the temperature control mechanism includes a temperature-controlled insulation barrel having a second inner cavity. The temperature-controlled insulation barrel is configured to control a temperature within the second inner cavity, and the cabin body is disposed within the second inner cavity.

Optionally, the constant gas-phase organic compound concentration generation apparatus further includes a flow field generating mechanism configured to generate a flow field at a position of the generating source.

Optionally, the cabin body includes a main body and a cover of the cabin. The main body is provided with a first opening in communication with the first inner cavity. The cabin cover is for sealing the first opening.

The flow field generating mechanism includes a driving mechanism and a blade. The blade is disposed within the first inner cavity. The driving mechanism is disposed outside the cabin cover. The driving mechanism is operatively connected to the blade to drive the blade to generate the flow field.

A pretreatment method for the constant gas-phase organic compound concentration generation apparatus is also provided in the present application. The pretreatment method includes:
preparing a viscous intermediate product including the carrier and the target organic compound; and
fabricating the generating source from the viscous intermediate product, and disposing the generating source within the cabin body.

Optionally, the carrier includes methyl cellulose, starch, and bentonite.

The preparing a viscous intermediate product includes: dispersing methyl cellulose, starch, and bentonite in water, and adding a target organic compound liquid to form a mixture; and stirring thoroughly the mixture under heating to gradually evaporate water therefrom until a viscous state is reached, thereby forming the viscous intermediate product.

Optionally, the pretreatment method further includes:
providing a substrate layer;
applying the viscous intermediate product onto the substrate layer to form the generating source in a film structure;
covering the generating source with a film layer to encapsulate the generating source; and
adhering the generating source to an inner wall of the cabin body via the substrate layer, and peeling off the film layer.

The beneficial effects of the constant gas-phase organic compound concentration generation apparatus and its pretreatment method provided in the present application are as follows: Compared with the existing art, the constant gas-phase organic compound concentration generation apparatus according to an embodiment of the present application includes a cabin body and a generating source disposed within the cabin body. The generating source includes a carrier and a target organic compound mixed in the carrier. The target organic compound is released in the cabin body by the generating source, thereby generating a constant gas-phase organic compound concentration. Compared to the existing dynamic dilution method, the constant gas-phase organic compound concentration generation apparatus of this embodiment has a simpler structure, lower cost, significantly reduced footprint, and simple and convenient operation. Since the content of the target organic compound in the generating source can be determined, the organic compound concentration within the cabin body can also be determined, thus ensuring the organic compound concentration inside the cabin body. Adjustable gas-phase concentration can be achieved simply through the preparation of the generating source material, fully enabling the constant generation of a broad spectrum of gas-phase organic compounds, including volatile organic compounds and semi-volatile organic compounds.

### BRIEF DESCRIPTION OF DRAWINGS

In order to clearly illustrate the technical solutions in embodiments of the present application, the following briefly describes the drawings required for describing the embodiments or the existing art. Obviously, the drawings in the following description are merely some embodiments of this application. For those of ordinary skill in the art, other drawings may be obtained based on these accompanying drawings without creative efforts.

FIG. 1 is a schematic diagram of a constant gas-phase organic compound concentration generating apparatus with a barrel cover closed according to an embodiment of the present application;

FIG. 2 is a schematic diagram of the constant gas-phase organic compound concentration generating apparatus with the barrel cover opened according to an embodiment of the present application;

FIG. 3 is an exploded schematic diagram of the constant gas-phase organic compound concentration generation apparatus according to an embodiment of the present application;

FIG. 4 is a schematic partial cross-sectional view of a constant gas-phase organic compound concentration generation apparatus according to an embodiment of the present application;

FIG. 5 is a schematic diagram of encapsulating a generating source in another embodiment of the present application;

FIG. 6 is a flow chart of a pretreatment method according to an embodiment of the present application;

FIG. 7 is a flow chart of preparation of a viscous intermediate product according to an embodiment of the present application; and

FIG. 8 is a flow chart of encapsulation and arrangement of a generating source according to an embodiment of the present application.

In the figures, the reference numerals indicate: cabin body 1; main body 11; cabin cover 12; generating source 2; substrate layer 21; film layer 22; protective layer 3; temperature-controlled insulation barrel 4; barrel cover 41; fastener 42; driving mechanism 51; blade 52; and sealing ring 6.

### DETAILED DESCRIPTION

To make the technical problem to be solved, the technical solution, and the beneficial effects of the present application clearer, the present application is described in further detail below with reference to the accompanying drawings and embodiments. It should be understood that the specific embodiments described herein are provided only for illustrating the present application and are not to be construed as limiting the present application.

It should be noted that when an element is described as being “fixed” or “disposed” to/on another element, it can be directly on or indirectly on the other element. When an element is described as being “connected to” another element, it can be directly connected to or indirectly connected to the other element.

It should be understood that the orientation or positional relationship indicated by the terms “length”, “width”, “upper”, “lower”, “front”, “rear”, “left”, “right”, “vertical”, “horizontal”, “top”, “bottom”, “inner”, “outer”, or the like are based on the orientation or positional relationship shown in the drawings. The orientation or positional relationship indicated by the terms is merely for the convenience of describing the present application and simplifying the description, rather than indicating or implying that the apparatus or element referred to must have a specific orientation, be constructed and operated in a specific orientation. Therefore, the orientation or positional relationship indicated by the terms cannot be understood as a limitation to the present application.

In addition, the terms “first”, “second”, and the like are used herein for descriptive purposes and can not be understood as indicating or implying relative importance or implicitly indicating the number of indicated technical features. Therefore, the features defined with “first” and “second” can explicitly or implicitly include one or more of the features. In the description of the present application, the meaning of “a plurality of” is two or more, unless otherwise specifically defined.

The generation of a constant and controllable concentration of a gas-phase organic compound is crucial in various application fields, such as scientific research, air quality sensor calibration testing, industrial process control, and odor and fragrance development, among others. If a controllable gas-phase organic concentration atmosphere cannot be effectively generated, it will directly affect the testing accuracy and application effect of related products, thereby leading to increased product cost, compliance issues, and even safety implications. Therefore, it is critical to use precise equipment and technology to control and detect the concentration of gas-phase organic compounds, ensuring product stability and consistency.

Currently, gas-phase organic compound concentration generation mainly adopts a dynamic dilution method, specifically, high-concentration organic vapor produced from a gas cylinder or by evaporating liquid organic compounds is mixed with clean air or an inert gas such as nitrogen to achieve the required concentration. Although this method can achieve the purpose of gas-phase organic compound concentration generation, it has the following problems:
complex equipment structure: it requires purchasing gas cylinders, gas pipelines and connectors, mass flow meters, the like, occupying a large area, and the apparatus setup and debugging process is complicated. The apparatus is complex and expensive, requiring regular calibration and maintenance, leading to high cost;
low precision and stability: when generating low gas-phase concentrations, any slight flow fluctuation will significantly affect the precision of the generated concentration, resulting in low robustness;
long response time: due to gas mixing and flow adjustment, the system requires a certain response time to reach a new set concentration, making rapid generation difficult; and
limited selectivity to organic compounds: this method is only suitable for high-volatility organic compounds, while low-volatility macromolecular organic compounds are difficult to generate and dilute, tend to remain in the pipeline flow channel, and are hard to generate.

In view of the shortcomings of the above gas-phase organic compound concentration generation apparatus, it is urgent to develop a simple and efficient constant gas-phase organic compound generation apparatus to simplify the gas-phase organic concentration generation process.

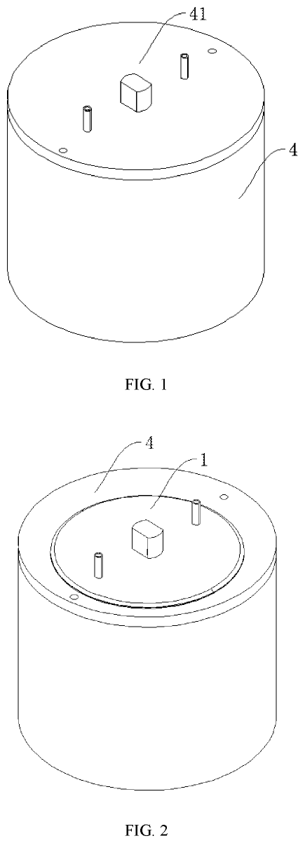

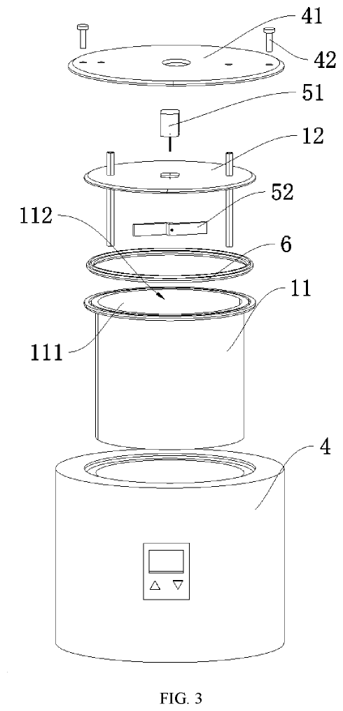

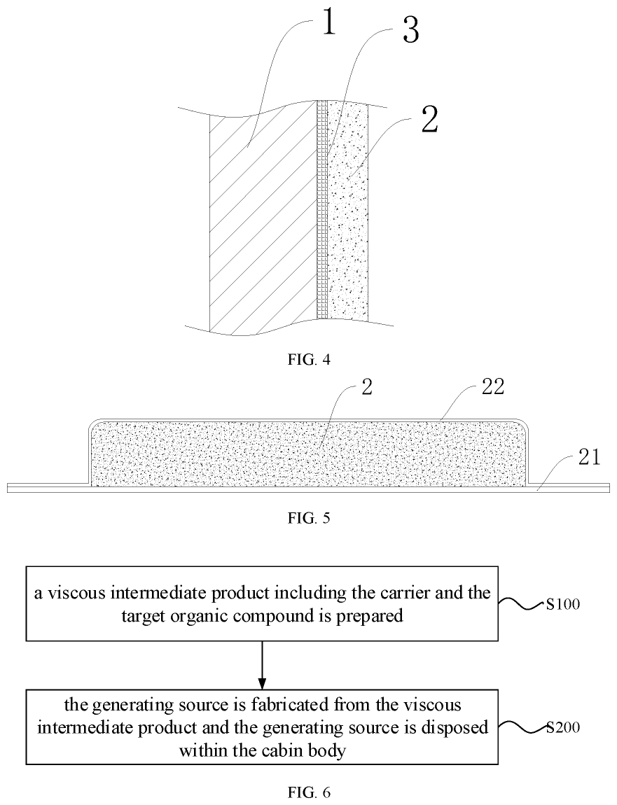

Referring to FIG. 1, FIG. 2, FIG. 3, and FIG. 4, the constant gas-phase organic compound concentration generation apparatus provided by an embodiment of the present application is described. The constant gas-phase organic compound concentration generation apparatus includes: a cabin body 1 having a sealable first inner cavity 111, and a generating source 2 arranged in the first inner cavity 111.

The generating source 2 includes a carrier and a target organic compound. The target organic compound is mixed within the carrier, is configured to be releasable from the carrier, and is configured to be mass-transferable into the first inner cavity 111.

In the embodiment, the cabin body 1 is a main body structure of the entire apparatus and has a sealable first inner cavity 111. The sealing property of the cabin body 1 can prevent interference from external gases on the internal environment, ensuring the stability of the internal gas-phase organic compound concentration, thereby enabling it to serve as a space for generating a gas-phase organic compound concentration. The first inner cavity 111 of the cabin body 1 is sealable. A sealing member for the cabin body 1 can be implemented in various forms, such as a cover, a gate, a sealing plate, and the like. The sealing member can be opened to place the generating source 2 into the first inner cavity 111 of the cabin body 1, and subsequently, the cabin body 1 can be sealed by closing the sealing member.

The generating source 2 is the origin for releasing the target organic compound via mass transfer. After the target organic compound is mass-transfer released into the cabin body 1, an atmosphere with a gas-phase organic concentration can be generated. The generating source 2 includes a carrier and a target organic compound. The target organic compound is mixed within the carrier. Through the action of the carrier, the target organic compound can be released into the gas phase inside the cabin body 1 at a certain rate. By controlling the type and properties of the carrier and the mixing ratio of the target organic compound within the carrier, the concentration of the gas-phase organic compound in the cabin body 1 can be precisely regulated. Herein, the carrier may be a porous material, a polymer substrate, or a specially prepared carrier. The target organic compound may encompass a broad spectrum of gas-phase organic compounds, including volatile organic compounds (e.g., benzene, toluene, or trichloroethylene, the like) and semi-volatile organic compounds (e.g., phthalate esters, organophosphate esters, or polybrominated diphenyl ethers, the like).

When using the constant gas-phase organic compound concentration generation apparatus to generate a gas-phase organic compound, the generating source 2 is placed in the first inner cavity 111 of the cabin body 1, and the first inner cavity 111 is sealed. The carrier in the generating source 2 then begins to act, releasing the target organic compound into the gas phase of the cabin body 1 at a certain rate. The sealing property of the chamber body 1 ensures relative stability of the internal gas phase, thereby allowing a constant gas-phase organic compound concentration to be maintained for a certain period. By adjusting the amount of the target organic compound in the generating source 2, the concentration and stability of the gas-phase organic compound can be further precisely controlled.

Compared to the existing dynamic dilution method, the constant gas-phase organic compound concentration generation apparatus of this embodiment has a simpler structure, lower cost, significantly reduced footprint, and is simple and convenient to operate. Since the content of the target organic compound in the generating source 2 is determinable, the organic compound concentration within the cabin body 1 is also determinable, thus ensuring the organic compound concentration inside the cabin body 1. Adjustable gas-phase concentration can be achieved simply through the preparation of the generating source material, fully enabling the constant generation of a broad spectrum of gas-phase organic compounds, including volatile organic compounds and semi-volatile organic compounds. Furthermore, the constant gas-phase organic compound concentration generation apparatus of this embodiment not only ensures stable gas-phase organic concentration inside the cabin body 1, thereby forming a constant organic compound concentration atmosphere inside, but also functions as an output generating source apparatus to supply constant gas-phase organic compounds to the external environment at a constant gas-phase concentration. That is, the embodiment can provide gas-phase organic concentration generation for both inside and outside the cabin of the apparatus, and is effectively applicable to various professional fields and application environments.

Referring to FIG. 4, in some embodiments of the present application, the generating source 2 is constructed as a film structure, and the film structure is disposed within the first inner cavity 111.

In this embodiment, the generating source 2 is constructed as a film structure. The film structure is flat and has a large surface area. It is primarily formed from a carrier material in which the target organic compound is mixed or loaded. The film structure is disposed within the first inner cavity 111 of the cabin body 1. This means it is directly exposed to the gaseous environment inside the cabin body 1 and can undergo full exchange with the gas therein, thereby releasing the target organic compound into the gas phase of the cabin body 1. The film structure may be disposed on the inner wall, top, bottom, or other locations of the cabin body 1. Alternatively, a component dedicated to supporting the film structure may be provided in the cabin body 1, with the film structure disposed thereon.

Compared to other structures, the film structure offers the following advantages: On the one hand, its large surface area enables full gas-phase exchange with the interior of the cabin body 1, allowing the target organic compound to achieve rapid and uniform concentration distribution within the cabin body 1. On the other hand, being a flat and thin structure, it shortens the diffusion path for the target organic compound to be released into the interior of the cabin body 1. This facilitates faster and more complete release of the organic compound, helps reduce the time required to establish the target gaseous organic concentration, and ensures the stability of the gaseous organic compound concentration inside the cabin body 1.

Furthermore, in addition to the film structure, the generating source 2 may take various other structures, such as block, sheet, granular, and the like.

Referring to FIG. 4, in some embodiments of the present application, a protective layer 3 is provided on an inner wall of the cabin body, and the generating source 2 is disposed on the protective layer 3. On the one hand, the protective layer 3 may isolate the film structure from the cabin body 1, thereby protecting the cabin body 1. On the other hand, the protective layer 3 may have a rough surface, which enhances the adhesion of the organic compound generating source 2 and ensures that the generating source 2 is securely attached to the inner wall of the cabin body 1. The protective layer 3 may be made from materials such as plastic film, masking tape, or the like.

Referring to FIG. 5, in some embodiments of the present application, the generating source is provided with a packaging structure for encapsulating the generating source. The packaging structure includes a substrate layer 21 and a film layer 22. The generating source is disposed on the substrate layer 21, the film layer 22 covers a side of the generating source opposite to the substrate layer, and the film layer 22 is configured to be removable from the generating source. The generating source adheres to the inner wall of the cabin body via the substrate layer 21.

In the period from when the generating source is prepared to placing the generating source in the cabin, the target organic compound in the generating source may volatilize. Therefore, in this embodiment, the generating source is provided with a packaging structure for encapsulating the generating source. The main function of the packaging structure is to prevent the generating source from volatilizing, so as to provide a relatively closed environment for the generating source, and the target organic compound is not allowed to be released until the generating source is placed in the cabin. The packaging structure primarily includes two parts: a substrate layer 21 and a film layer 22.

The substrate layer 21 serves as a supporting base for the generating source, providing stable support. It also performs the function of connecting to the inner wall of the cabin body, enabling the generating source to be securely installed inside the cabin body. The film layer 22 covers a side of the generating source opposite the substrate layer 21. Together with the substrate layer 21, it forms a relatively sealed space that completely envelops the generating source, thereby further enhancing the barrier effect against volatilization of the target organic compound. In selecting materials for the substrate layer 21 and the cover film layer 22, the primary consideration is that they do not react with the target organic compound. However, the requirements for the substrate layer 21 and the film layer 22 differ. The substrate layer 21 needs to provide stable support for the generating source. Therefore, it requires substantial strength, which may be ensured, for example, by increasing its thickness. Additionally, it must ensure the stable attachment of the generating source to itself. Hence, the surface of the substrate layer 21 in contact with the generating source may be processed to be rough, enabling good contact and preventing separation. In contrast, the film layer 22 may be made of a lighter and thinner material, and it can be easily peeled away from the generating source. Specifically, the substrate layer 21 may be made from materials such as modified silicone or polyurethane, which bond more readily with the generating source. Its surface can be processed to be rough. The cover film layer 22 may be made from materials such as expanded polytetrafluoroethylene or fluorinated polymers, which are more easily peelable.

In some embodiments of the present application, the carrier includes starch, bentonite, and methyl cellulose. Starch is a natural polymer capable of forming a film. It provides the primary skeletal structure in the paste and may form a film structure after drying. Therefore, it serves as the primary film-forming matrix. Bentonite is a layered silicate mineral with good water absorbency and dispersibility. Adding it to starch can improve the tensile strength and toughness of the film. In a viscous state, bentonite can increase viscosity and improve adhesion. Furthermore, the water-absorbing and swelling properties of the bentonite enable the carrier to form a porous structure after drying, thereby allowing for better loading of more target organic compounds. Methyl cellulose is a water-soluble cellulose derivative. It can increase viscosity in the viscous state, facilitating adhesion and enhancing the toughness of the film formed.

The carrier of the embodiment, including methyl cellulose, starch, and bentonite, can not only better load the target organic compound but also contribute to forming a stable film structure.

In some embodiments of the present application, the constant gas-phase organic compound concentration generation apparatus further includes a temperature control mechanism for controlling the temperature in the first inner cavity 111.

Based on the inventor's scientific research, temperature is a key factor determining the robustness of the gas-phase organic concentration generation apparatus. Therefore, the constant gas-phase organic compound concentration generation apparatus of this embodiment further includes a temperature control mechanism to control the temperature within the first inner cavity 111, thereby ensuring a stable internal temperature in the cabin body 1 of the apparatus. The temperature control mechanism may adopt a heating system or an air conditioning system. To achieve precise temperature control, it is typically integrated with a temperature sensor. The sensor monitors the temperature inside the cabin body 1 in real time and feeds the data back to a control system for necessary adjustments. Based on a preset temperature range and the data provided by the sensor, the control system automatically adjusts its output to maintain a constant temperature inside the cabin body 1. By precisely stabilizing the temperature within the first inner cavity 111, the robustness of the gas-phase organic concentration generation apparatus can be significantly enhanced.

Referring to FIG. 1, FIG. 2, and FIG. 3, in some embodiments of the present application, the temperature control mechanism includes a temperature-controlled insulation barrel 4 having a second inner cavity. The temperature-controlled insulation barrel 4 is configured to control a temperature within the second inner cavity, and the cabin body 1 is disposed within the second inner cavity.

The temperature control mechanism of the present embodiment adopts a temperature-controlled insulation barrel 4. The temperature-controlled insulation barrel 4 has a second inner cavity, whose space is designed to accommodate the cabin body 1 and control the temperature. The size and shape of the second inner cavity may be customized according to the size and shape of the cabin body 1 to ensure that the cabin body 1 can be fully placed therein. The temperature-controlled insulation barrel 4 controls the temperature in the second inner cavity through its built-in heating or cooling system. The system automatically adjusts according to a preset temperature range or data provided by sensors to ensure that the cabin body 1 and the gas-phase organic compound inside it are under optimal temperature conditions. The temperature-controlled insulation barrel 4 is designed to provide effective thermal insulation, isolating interference from external temperature fluctuations, thereby ensuring the stability of the organic compound concentration in the apparatus. The temperature-controlled insulation barrel 4 can also ensure that the temperature distribution in the second inner cavity is more uniform. This is crucial for the uniform distribution and concentration stability of gas-phase organic compounds in the cabin body 1.

To cooperate with the temperature-controlled insulation barrel 4, the cabin body 1 can be designed to have relatively good thermal conductivity, for example, it can be made of metal. This allows the temperature-controlled insulation barrel 4 to better regulate the temperature of the cabin body 1 inside it.

The temperature-controlled insulation barrel 4 can be provided with a corresponding barrel cover 41 and a fastener 42. The barrel cover 41 is used to seal the temperature-controlled insulation barrel 4, reduce heat loss, and improve the stability of temperature control. The fastener 42 is used to fix the barrel cover 41 on the temperature-controlled insulation barrel 4. The shape of the barrel cover 41 is determined according to the temperature-controlled insulation barrel 4. The fastener 42 can adopt structures such as a bolt or a buckle. In the embodiment shown in FIG. 1, the fastener 42 adopts a bolt. By tightly connecting the barrel cover 41 and the temperature-controlled insulation barrel 4 with the fastener 42, the cabin cover 12 can also be pressed against the main body 11, thereby improving the airtightness of the cabin body 1.

In some embodiments of the present application, the constant gas-phase organic compound concentration generation apparatus further includes a flow field generating mechanism configured to generate a flow field at a position of the generating source 2.

Based on the scientific research results of the inventors, the flow field is a key factor determining the rapid responsiveness of the gas-phase organic compound concentration generation apparatus. Therefore, the constant gas-phase organic compound concentration generation apparatus of the present embodiment further includes a flow field generating mechanism. The main function of the flow field generating mechanism is to form a flow field inside the apparatus. In particular, the flow field generating mechanism is configured to generate a flow field at the position of the generating source 2. The flow field can promote the rapid release of the target organic compound in the generating source 2 and help the target organic compound to be rapidly and uniformly dispersed throughout the entire cabin body 1. The flow field generating mechanism can adopt an apparatus that disturbs air flow, for example, a rotating or flapping blade 52.

Referring to FIG. 1, FIG. 2, and FIG. 3, in some embodiments of the present application, the cabin body 1 includes a main body 11 and a cabin cover 12. The main body 11 is provided with a first opening 112 in communication with the first inner cavity 111, and the cabin cover 12 is for sealing the first opening 112. The flow field generating mechanism includes a driving mechanism 51 and a blade 52. The blade 52 is disposed within the first inner cavity 111, the driving mechanism 51 is disposed outside the cabin cover 12, and the driving mechanism 51 is operatively connected to the blade 52 to drive the blade 52 to generate the flow field.

The main body 11 is the main component of the cabin body 1 and may form the first inner cavity 111. The main body 11 is provided with a first opening 112 communicating with the first inner cavity 111 inside the cabin body 1. That is, the first opening 112 is actually the opening of the first inner cavity 111. The cabin cover 12 is a detachable or movable component used to close the first opening 112 on the main body 11. When the cabin cover 12 is closed, it tightly fits with the main body 11 to form a complete and enclosed space of the cabin body 1. A sealing ring 6 may also be provided between the cabin cover 12 and the main body 11 to ensure the sealing performance of the cabin cover 12.

In this embodiment, the flow field generating mechanism includes the driving mechanism 51 and the blade 52. The driving mechanism 51 is the power-generating source of the flow field generating mechanism, it is located on the outer side of the cabin cover 12, i.e., the side facing away from the first inner cavity 111. This arrangement prevents the driving mechanism 51 from contaminating the interior space of the first inner cavity 111. On the other hand, it also facilitates maintenance. The driving mechanism 51 can be a motor, a hydraulic motor, or another apparatus capable of providing rotational power. The main function of the driving mechanism 51 is to drive the blade 52 to rotate, thereby generating the desired flow field.

The blade 52 is a key component of the flow field generating mechanism and is disposed in the first inner cavity 111 of the main body 11. The driving mechanism 51 and the blade 52 are in transmission connection, thus the power from the driving mechanism 51 can be transmitted to the blade 52 to drive its rotation. The driving mechanism 51 and the blade 52 can generally employ transmission methods such as shaft transmission or magnetic transmission. Taking shaft transmission as an example, the transmission shaft may pass through the cabin cover 12. It should be noted that a seal is required between the transmission shaft and the cover 12 to ensure the airtightness of the first inner cavity 111.

Based on the above structure design, a mass conservation equation for the dynamic change of organic compound concentration on the air side in the cabin can be constructed as shown in formulas (1) and (2):

$$V \frac{dC}{dt} = Q ( 0 - C ) + {h}_{m} A ( {C}_{sur} - C ) \qquad ( 1 )$$

$${C}_{0 , sour} = {K}_{sour} {C}_{sur} \qquad ( 2 )$$

where V (m³) is the volume of the cabin body 1 of the apparatus; C (μg/m³) is the organic compound concentration in the cabin, varying hourly with time t (h); Q (m³/h) is the ventilation rate of the cabin; hₘ(m/h) is the convective mass transfer coefficient between the air in the cabin and the organic film, which determines the release rate of organic compound from the generating source material and is significantly influenced by air disturbance in the cabin; A (m²) is the surface area of the generating source material within the cabin; Cₛᵤᵣ(μg/m³) is the gas-phase concentration at the surface layer of the generating source material, which can be regarded as constant over a sufficiently long period, and is proportional to its dimensionless mass fraction C_{0,sour} within the generating source material. The proportionality coefficient is defined as the distribution coefficient Kₛₒᵤᵣ (m³/μg) of the generating source material.

By combining formulas (1) and (2), the analytical solution to this differential equation can be obtained as shown in formula (3):

$$C = \frac{{h}_{m} {AC}_{0 , sour}}{( Q + {h}_{m} A ) {K}_{sour}} [ 1 - exp ( - \frac{Q + {h}_{m} A}{V} t ) ] \qquad ( 3 )$$

From the analytical solution, it is readily apparent that concentration C in the cabin is positively correlated with the organic compound content C_{0,sour} in the generating source material. Different gas-phase organic compound concentrations in the cabin can be directly obtained by changing the proportion of pure liquid in the organic film of the generating source material. The distribution coefficient Kₛₒᵤᵣ of the generating source material in the formula changes significantly with temperature. Ensuring a constant temperature can avoid fluctuations in this value and in the cabin concentration C. The mass transfer coefficient hₘ is directly coupled with time t. A larger hₘ ensures that the term

$$exp ( - \frac{Q + {h}_{m} A}{V} t )$$

decays rapidly to zero over time, thereby significantly reducing the response time of C and enabling rapid establishment of the concentration within the cabin. Therefore, it can be seen that in the embodiments of the present application, the temperature control mechanism is utilized to precisely control the temperature and isolate disturbances from the external environment, thereby achieving high stability of the generated gas-phase organic compound. The flow field generating mechanism is utilized to create air turbulence within the cabin, thereby increasing the mass transfer coefficient of the flow field and accelerating the release of gas-phase organic compounds. Consequently, the time required to establish the corresponding gas-phase organic compound concentration is short.

According to the aforementioned constant gas-phase organic compound concentration generation apparatus, the present application further provides a pretreatment method. This pretreatment method is used for the constant gas-phase organic compound concentration generation apparatus. That is, this pretreatment method is the preparation step before the apparatus establishes a constant gas-phase organic compound concentration.

Referring to FIG. 6, the pretreatment method includes: S100 and S200.

In S100, a viscous intermediate product including the carrier and the target organic compound is prepared.

In S200, the generating source 2 is fabricated from the viscous intermediate product, and the generating source is disposed within the cabin body 1.

The step of preparing a viscous intermediate product includes mixing the carrier and the target organic compound to form the viscous intermediate product. The carrier may be a material capable of combining with the target organic compound to form a viscous state, which facilitates the uniform attachment of the target organic compound within the cabin body 1. The target organic compound is the substance to be released in the constant gas-phase concentration generation apparatus. This method can ensure its uniform distribution and stable release within the apparatus.

The prepared viscous intermediate product is further processed into a specific shape or structure to meet the requirements for serving as a generating source. This may include processing the viscous material into a structure of sheet, block, granule, or the like. For example, a mold may be used to press the viscous intermediate product into a sheet-shaped generating source with a specific configuration, facilitating its subsequent installation in the cabin body 1. During the forming process, it is necessary to maintain the mixed state of the target organic compound and the carrier unchanged, so as to avoid leakage or non-uniform distribution of the target organic compound. The key to this step is to ensure the uniformity and integrity of the attachment, so that the target organic compound can be released stably and uniformly during the subsequent constant gas-phase concentration establishment process.

The fabricated generating source 2 is placed inside the cabin body 1 in a specific manner. Due to differences in the structure and usage requirements of the cabin body 1, the installation methods may vary. For example, after fabrication, the generating source can be directly coated onto the inner wall of the cabin body 1. Alternatively, if the generating source is disposed on a substrate layer 21, the generating source may be adhered to the inner wall of the cabin body 1 via the substrate layer 21.

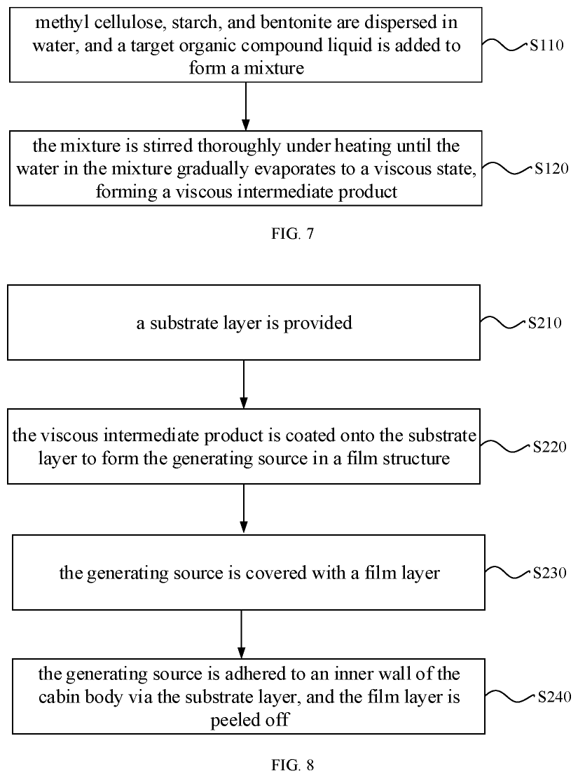

Please refer to FIG. 7. In some embodiments of the present application, the carrier includes starch, bentonite, and methyl cellulose. The step of preparing a viscous intermediate product includes: S110 and S120.

In S110, methyl cellulose, starch, and bentonite are dispersed in water, and a target organic compound liquid is added to form a mixture.

In S120, the mixture is stirred thoroughly under heating until the water in the mixture gradually evaporates to a viscous state, forming a viscous intermediate product.

The carrier includes starch, bentonite, and methyl cellulose. The starch is a natural polymer with film-forming capability. It provides the primary skeletal structure in the paste and may form a film structure after drying. Therefore, it serves as the primary film-forming matrix. Bentonite is a layered silicate mineral with good water absorbency and dispersibility. Adding it to starch can improve the tensile strength and toughness of the film. In a viscous state, bentonite can increase viscosity and improve adhesion. Furthermore, the water-absorbing and swelling properties of the bentonite enable the carrier to form a porous structure after drying, thereby allowing for better loading of more target organic compounds. Methyl cellulose is a water-soluble cellulose derivative. It can increase viscosity in the viscous state, facilitating adhesion and enhancing the toughness of the film formed.

During preparation, methyl cellulose, starch, and bentonite are dispersed in a suitable amount of water, and the target organic compound liquid is added to form a mixture. The order of addition for these components can be adjusted as needed. However, first dispersing the methyl cellulose, starch, and bentonite in an appropriate amount of water and then adding the target organic compound liquid, facilitates better adjustment of the target organic substance's addition amount.

The mixture is stirred thoroughly under heating. Heating helps accelerate water evaporation and promotes uniform mixing of the components. Thorough stirring ensures that all components are in full contact and react to form a uniform viscous material. As heating and stirring proceed, the water in the mixture gradually evaporates. When the water has evaporated to a certain extent, the mixture becomes viscous, forming the viscous intermediate product that can be attached to the interior of the cabin body 1.

The generating source 2 of this embodiment is prepared by mixing the target organic compound with methyl cellulose, starch, and bentonite. This ensures uniform distribution of the target organic compound within the carrier, leading to a more uniform and controlled release of the target organic compound for generating a constant gas-phase organic compound concentration.

In one embodiment of the present application, the pretreatment method is as follows: 0.2 g of methylcellulose, 10 g of starch, and 4 g of bentonite were thoroughly dispersed in 20 g of water at 80° C. 0-10 g of pure target organic compound liquid is added to this solution. The solution is stirred thoroughly under heating to gradually evaporate the water until a viscous state is achieved. Equipment such as a planetary ball mill or a magnetic stirrer can be used to assist stirring. The interior of the tank cabin 1 is fully covered with masking tape. The viscous organic film is attached to the surface of the masking tape, thereby completing the preparation of the generating source. By adjusting the proportion of the target organic compound pure liquid, gas-phase organic compound atmospheres at different concentrations can be created.

Referring to FIG. 8, in some embodiments of the application, the step of fabricating the generating source from the viscous intermediate product and disposing the generating source within the cabin body includes: S210, S220, S230, and S240.

In S210, a substrate layer 21 is provided. The substrate layer 21 serves as the support base for the generating source, and its properties are crucial. It needs to possess good flexibility to conform to the inner walls of cabin bodies with various shapes, particularly common curved inner walls. Meanwhile, the substrate layer 21 have stable chemical properties and does not react chemically with the carrier or the target organic compound in the viscous intermediate product, thereby ensuring the stability of the entire generating source.

In S220, the viscous intermediate product is coated onto the substrate layer 21 to form the generating source in a film structure. This step is crucial for constructing the generating source. The coating operation needs to be uniform and precise to ensure the viscous intermediate product forms a film structure with consistent thickness on the substrate layer 21. If the coating is uneven, it may lead to an inconsistent release rate of the target organic compound in the subsequent process, thereby affecting the stability of the gas-phase organic compound concentration inside the cabin body. The coating operation may be performed using various techniques, such as blade coating or spray coating. In the blade coating, a blade is used to uniformly spread the viscous intermediate product on the surface of the substrate layer 21. In the spray coating, a spray gun is used to uniformly apply the viscous intermediate product in a mist form onto the substrate layer 21. Through such a coating operation, the viscous intermediate product, composed of the carrier and the target organic compound, adheres closely to the substrate layer 21, preliminarily forming a generating source with specific structure and function. The film structure facilitates more uniform diffusion of the target organic compound during the subsequent release process.

In S230, the generating source is covered with a film layer to encapsulate the generating source. The primary function of the film layer 22 is to prevent the target organic compound from volatilizing before the generating source is installed into the cabin body. The film layer 22 also needs to allow for easy removal (peeling off) in subsequent steps. The covering operation needs to ensure that the film layer 22 is in intimate contact with the generating source without gaps, thereby forming a relatively sealed enclosure. This tightly encapsulates the target organic compound within the structure formed by the substrate layer 21 and the film layer 22, maintaining its stability until the generating source is subsequently placed into the cabin body for release.

In S240, the generating source is adhered to an inner wall of the cabin body via the substrate layer 21, and the film layer 22 is peeled off. Prior to the adherence operation, the inner wall of the cabin body needs to be cleaned and pretreated to remove impurities such as dust and oil stains from the surface, thereby enhancing the adhesion between the substrate layer 21 and the cabin body's inner wall. Then, the substrate layer 21 bearing the generating source is accurately adhered to the predetermined location on the inner wall of the cabin body. This ensures the stable installation of the generating source, preventing displacement during the operation of the cabin body. Once the generating source is adhered, the film layer 22 can be removed. The timing for removing the film layer 22 is usually determined based on experimental or application requirements. Upon removal, the target organic compound becomes exposed to the inner cavity environment of the cabin body. Over time, it gradually undergoes mass transfer from the carrier into the gas-phase space of the cabin body, initiating the generation of a constant gas-phase organic compound concentration.

In some embodiments of this application, to ensure that the generating source is easy to transport, store, and use after packaging, the generating source and its packaging structure can be fabricated in sections. Specifically, before coating the viscous intermediate product onto the substrate layer 21, a separation mold, such as a grid structure, can be placed on it. This mold not only separates the coated viscous intermediate product into multiple blocks but also helps control the coating thickness. The separation distance must account for the secure wrapping by the film layer 22 and the subsequent cutting. Subsequent to coating the viscous intermediate product onto the substrate 21 and upon the formation of stable segmented generating sources, the separation mold may be removed, followed by covering the generating source with the film layer 22. After the covering step, the film layer 22 can be made to conform tightly to the generating source and the substrate layer 21 by means of pressing with a flexible object, applying vacuum suction, or the like. Finally, the film layer 22 and the substrate layer 21 may be cut at the separation of the generating source, forming individually encapsulated generating sources. These individually encapsulated generating sources can withstand external forces such as vibration and impact during transportation, preventing leakage of the target organic compound or contamination from the external environment. This significantly ensures transportation safety. During storage, the stable encapsulation structure can reduce the interference of environmental factors such as humidity and temperature change on the target organic compound, and prolong the effective storage period. During use, the independently packaged generating source is convenient for on-demand applications. It can be directly installed on the inner wall of the cabin body. The operation is simple and convenient, requiring no additional complex processing, thereby effectively enhancing usage efficiency.

The foregoing descriptions are merely preferred embodiments of the present application and are not intended to limit the present application. Any modifications, equivalent substitutions, and improvements made within the spirit and principles of the present application shall fall within the protection scope of the present application.

1. A constant gas-phase organic compound concentration generation apparatus, comprising:
a cabin body, wherein the cabin body has a sealable first inner cavity; and
a generating source, wherein the generating source is arranged in the first inner cavity;
wherein the generating source comprises a carrier and a target organic compound, the target organic compound is mixed within the carrier, and is configured to be mass-transferable into the first inner cavity; and
wherein the generating source is constructed as a film structure, the film structure is disposed within the first inner cavity, and the film structure is disposed on an inner wall, top, bottom, or a component dedicated to supporting the film structure of the cabin body.

2. The constant gas-phase organic compound concentration generation apparatus according to claim 1, wherein a protective layer is provided on an inner wall of the cabin body, and the generating source is disposed on the protective layer.

3. The constant gas-phase organic compound concentration generation apparatus according to claim 1,
wherein
the generating source is provided with a packaging structure for encapsulating the generating source;
the packaging structure comprises a substrate layer and a film layer, the generating source is disposed on the substrate layer, the film layer covers a side of the generating source opposite to the substrate layer, and the film layer is configured to be removable from the generating source; and
the generating source is adhered to an inner wall of the cabin body via the substrate layer.

4. The constant gas-phase organic compound concentration generation apparatus according to claim 1,
wherein
the carrier comprises at least one of starch, bentonite, and methyl cellulose; and/or
the target organic compound comprises at least one of benzene, toluene, trichloroethylene, phthalate esters, organophosphate esters, and polybrominated diphenyl ethers.

5. The constant gas-phase organic compound concentration generation apparatus according to claim 1, wherein the constant gas-phase organic compound concentration generation apparatus further comprises a temperature control mechanism for controlling a temperature in the first inner cavity.

6. The constant gas-phase organic compound concentration generation apparatus according to claim 5, wherein the temperature control mechanism comprises a temperature-controlled insulation barrel having a second inner cavity, the temperature-controlled insulation barrel being configured to control a temperature within the second inner cavity, and the cabin body is disposed within the second inner cavity.

7. The constant gas-phase organic compound concentration generation apparatus according to claim 1, wherein the constant gas-phase organic compound concentration generation apparatus further comprises a flow field generating mechanism configured to generate a flow field at a position of the generating source.

8. The constant gas-phase organic compound concentration generation apparatus according to claim 7,
wherein
the cabin body comprises a main body and a cabin cover, the main body is provided with a first opening in communication with the first inner cavity, and the cabin cover is configured for sealing the first opening; and
the flow field generating mechanism comprises a driving mechanism and a blade, the blade is disposed within the first inner cavity, the driving mechanism is disposed outside the cabin cover, and the driving mechanism is operatively connected to the blade to drive the blade to generate the flow field.

9. A pretreatment method for the constant gas-phase organic compound concentration generation apparatus according to claim 1, the pretreatment method comprising:
preparing a viscous intermediate product comprising the carrier and the target organic compound; and
fabricating the generating source from the viscous intermediate product and disposing the generating source within the cabin body.

10. The pretreatment method according to claim 9,
wherein the carrier comprises methyl cellulose, starch, and bentonite; and
wherein the preparing a viscous intermediate product comprises:
dispersing the methyl cellulose, starch, and bentonite in water, and adding a target organic compound liquid to form a mixture; and
stirring the mixture under heating to gradually evaporate water therefrom until a viscous state is reached, thereby forming the viscous intermediate product.

11. The pretreatment method according to claim 9, wherein the fabricating the generating source from the viscous intermediate product and disposing the generating source within the cabin body comprises:
providing a substrate layer;
applying the viscous intermediate product onto the substrate layer to form the generating source in a film structure;
covering the generating source with a film layer to encapsulate the generating source; and
adhering the generating source to an inner wall of the cabin body via the substrate layer, and peeling off the film layer.
